(19) United States
(12) Patent Application Publication
(10) Pub. No.: US 2018/0209518 A1
(43) Pub. Date: Jul. 26, 2018

(54) VEHICLE

(71) Applicant: TOYOTA JIDOSHA KABUSHIKI KAISHA, Toyota-shi (JP)

(72) Inventor: Yushi SEKI, Susono-shi (JP)

(73) Assignee: TOYOTA JIDOSHA KABUSHIKI KAISHA, Toyota-shi (JP)

(21) Appl. No.: 15/876,874

(22) Filed: Jan. 22, 2018

(30) Foreign Application Priority Data
Jan. 23, 2017 (JP) 2017-009587

(51) Int. Cl. F16H 15/28; F16H 15/40; F16H 15/52; B60K 7/00

(52) U.S. Cl. CPC F16H 15/28; F16H 15/40; B60L 15/2054; B60K 7/0007; F16H 15/52

(57) ABSTRACT

In a vehicle installed with in-wheel motors, a continuously variable transmission provided in a power transmission path between the in-wheel motor and a wheel has an input member that rotates as a unit with a rotor, an output member that rotates as a unit with a drive shaft, planetary balls that transmit torque between the input member and the output member, a support shaft that rotatably supports each of the planetary balls, and a carrier that can tilt the planetary balls by changing the radial positions of opposite end portions of the support shaft. The continuously variable transmission can change the speed ratio by changing the tilting angle of the planetary balls by means of the carrier.

### INCORPORATION BY REFERENCE

The disclosure of Japanese Patent Application No. 2017-009587 filed on Jan. 23, 2017 including the specification, drawings and abstract is incorporated herein by reference in its entirety.

### BACKGROUND

### 1. Technical Field

The disclosure relates to a vehicle.

### 2. Description of Related Art

A vehicle in which an in-wheel motor that provides power for traveling is placed inside each wheel is described in Japanese Patent Application Publication No. 2009-213227 (JP 2009-213227 A). In the vehicle, power generated from the in-wheel motor is transmitted to the wheel, via a reduction gear mechanism.

### SUMMARY

However, in the vehicle described in JP 2009-213227 A, the speed ratio cannot be changed during traveling since the gear ratio of the reduction gear mechanism is fixed, and the vehicle may not be able to exhibit sufficient power characteristics. Also, in the vehicle including the in-wheel motors, it is difficult, in terms of mountability, to provide a conventional automatic transmission or belt-type continuously variable transmission in a power transmission path between the in-wheel motor and the wheel.

The disclosure provides a vehicle in which a continuously variable transmission is provided in a power transmission path between an in-wheel motor and a wheel, in view of mountability of the transmission on the vehicle.

An aspect of the present disclosure relates to a vehicle including a plurality of wheels. The vehicle includes a plurality of wheels includes an in-wheel motor placed inside each of the wheels and including a rotor and a stator, and a continuously variable transmission provided for at least one of the wheels and placed in a power transmission path between the in-wheel motor and a corresponding one of the wheels. The continuously variable transmission is configured to steplessly change a speed ratio. The continuously variable transmission includes an annular input member, an annular output member, a plurality of planetary balls, a support shaft, and a carrier. The annular input member rotates as a unit with the rotor. The annular output member rotates as a unit with a drive shaft of the corresponding one of the wheels. The plurality of the planetary balls sandwiched between the input member and the output member that are arranged to be opposed to each other in an axial direction of the drive shaft. The planetary balls are configured to transmit torque between the input member and the output member. The support shaft includes opposite end portions that protrude from each of the planetary balls, and supports the planetary ball such that the planetary ball is rotatable about an axis of rotation that is different from that of the drive shaft. The carrier configured to tilt the planetary balls, by changing positions of the opposite end portions of the support shaft along a radial direction of the drive shaft, without changing a position of a center of gravity of the planetary ball. The continuously variable transmission is configured to change the speed ratio by changing a tilting angle of the planetary balls.

With the above aspect, in the vehicle including the in-wheel motors, the continuously variable transmission of which the speed ratio is variable can be provided in a power transmission path between the in-wheel motor and the corresponding wheel. Thus, the speed ratio can be changed during traveling, and the vehicle can exhibit sufficient power characteristics. Further, the speed ratio can also be changed during regenerative braking, so that the amount of electric power regenerated by the in-wheel motor can also be increased. Also, since the continuously variable transmission can change its speed ratio by changing the tilting angle of the planetary balls, it has a smaller structure as compared with the conventional automatic transmission and belt-type continuously variable transmission. Thus, the continuously variable transmission can be readily installed on the vehicle.

According to the disclosure, it is possible to provide the continuously variable transmission of which the speed ratio is variable, in the power transmission path between the in-wheel motor and the corresponding wheel. Thus, the speed ratio can be changed during traveling, and the vehicle installed with the in-wheel motors can exhibit sufficient power characteristics.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a skeleton diagram schematically showing a vehicle of a first embodiment;

FIG. 2 is a view schematically showing the internal structure of an in-wheel motor and a continuously variable transmission;

FIG. 3 is an enlarged view of the continuously variable transmission shown in FIG. 2; and

FIG. 4 is a view schematically showing the internal structure of an in-wheel motor and a continuously variable transmission according to a second embodiment.

### DETAILED DESCRIPTION OF EMBODIMENTS

Vehicles according to some embodiments of this disclosure will be specifically described, referring to the drawings.

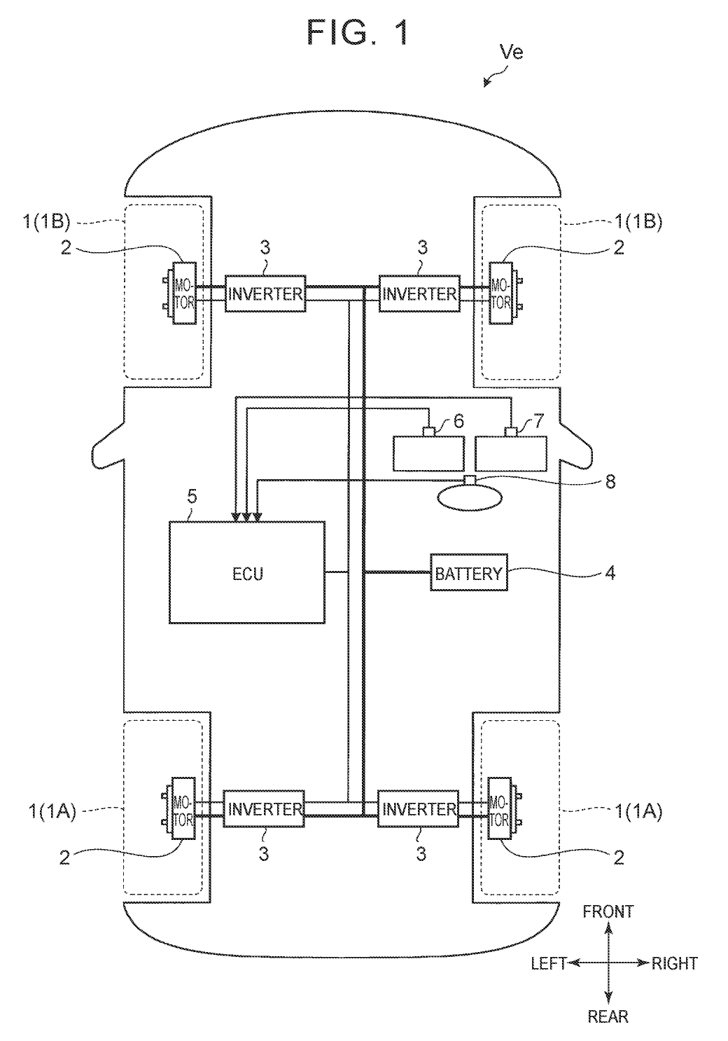

FIG. 1 is a skeleton diagram schematically showing a vehicle of a first embodiment. As shown in FIG. 1, the vehicle Ve is an electric vehicle in which in-wheel motors 2 serving as power sources for traveling are placed inside respective wheels 1. The vehicle Ve shown in FIG. 1 has four wheels 1, i.e., right front, left front, right rear, and left rear wheels, and each wheel 1 is provided with the in-wheel motor 2. On the vehicle Ve, the same number of in-wheel motors 2 as the wheels 1 are installed.

The wheels 1 are driven by power generated from the corresponding in-wheel motors 2. The in-wheel motors 2 are electric motors that function as power sources for traveling. Each of the in-wheel motors 2 is provided with an inverter 3. Each inverter 3 is electrically connected to a battery 4. On the vehicle Ve, an ECU 5 that performs drive control on the in-wheel motors 2 is installed.

The ECU 5 performs various controls (drive control, braking control, turning control) on the in-wheel motors 2, based on signals received from an accelerator sensor 6, brake sensor 7, and a steering angle sensor 8, which are installed on the vehicle Ve. The accelerator sensor 6 detects the amount of depressing operation on an accelerator pedal (accelerator operation amount). The brake sensor 7 detects the amount of depressing operation on a brake pedal (brake operation amount). The steering angle sensor 8 detects the steering angle of a steering wheel.

During drive control of the in-wheel motors 2, the ECU 5 calculates a motor torque command value for each of the in-wheel motors 2, based on a signal (accelerator operation amount) received from the accelerator sensor 6, and outputs a signal (torque command) indicative of the motor torque command value, to a corresponding one of the inverters 3. The inverter 3 causes given current (excitation current) to flow through the in-wheel motor 2, based on the torque command received from the ECU 5. During braking control, the ECU 5 causes the in-wheel motors 2 to function as generators, to perform regenerative braking, based on a signal (brake operation amount) received from the brake sensor 7. At this time, the battery 4 can be charged with electric power generated by the in-wheel motors 2. Further, during turning control, the ECU 5 changes the output balance of the respective in-wheel motors 2 of the front and rear, right and left wheels, based on a signal (the steering angle of the steering wheel) received from the steering angle sensor 8, so as to stabilize the attitude of the vehicle Ve during turning. In this manner, the ECU 5 can assist turning of the vehicle Ve.

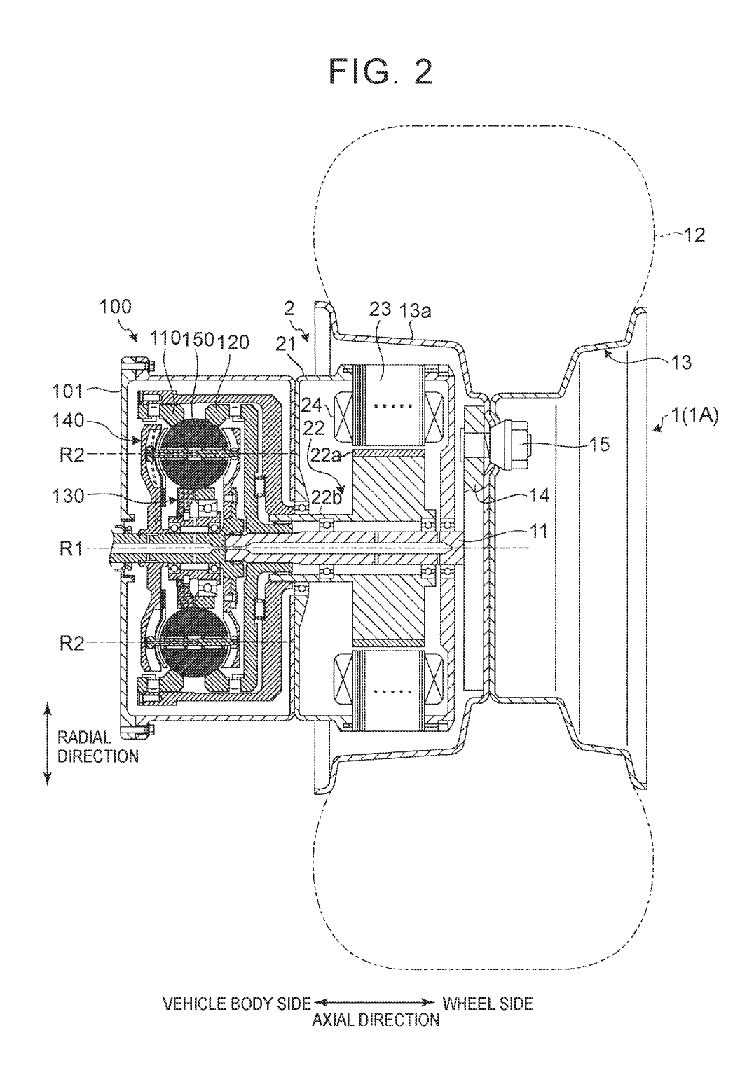

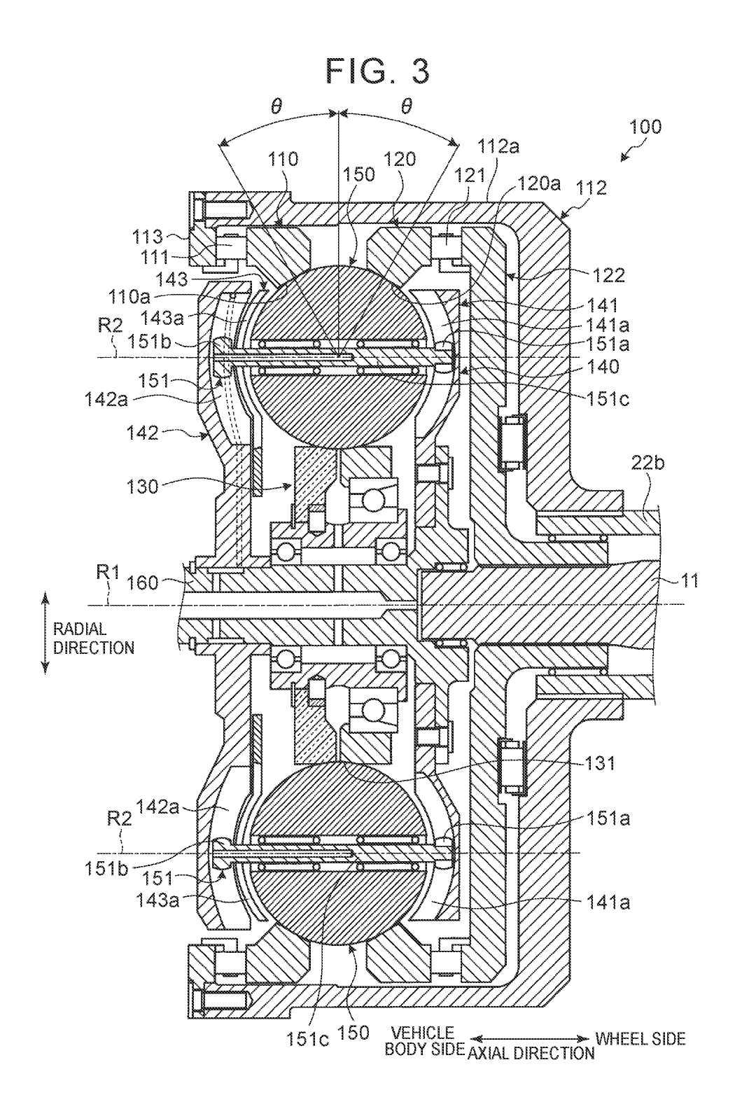

In the vehicle Ve, continuously variable transmissions 100 (shown in FIG. 2) capable of steplessly changing the speed ratio are installed in power transmission paths between some of the wheels 1 and the corresponding in-wheel motors 2. The continuously variable transmission 100 is in the form of a so-called ball planetary type continuously variable transmission, or continuously variable planetary transmission (CVP). Further, shift actuators (not shown) that operate under control of the ECU 5 are installed on the vehicle Ve. When the shift actuator operates, the continuously variable transmission 100 performs shift operation, i.e., changes its speed ratio. The detailed configuration of the continuously variable transmission 100 will be described later, referring to FIG. 2 and FIG. 3.

The continuously variable transmissions 100 are provided only in main drive wheels 1A of the wheels 1, and are not provided in steerable wheels 1B. The main drive wheels 1A refer to the wheels 1 other than the steerable wheels 1B. Since the vehicle Ve is a four-wheel-drive vehicle in which all of the wheels 1 are drive wheels, the steerable wheels 1B may be referred to as auxiliary drive wheels.

The vehicle Ve shown in FIG. 1 has front wheels that are the steerable wheels 1B, and rear wheels that are the main drive wheels 1A. In this case, the continuously variable transmissions 100 are provided only in the rear wheels (main drive wheels 1A); therefore, power of the in-wheel motors 2 is transmitted to the rear wheels (main drive wheels 1A) via the continuously variable transmissions 100. On the other hand, the front wheels (steerable wheels 1B) are not connected to the continuously variable transmissions 100; therefore, power of the in-wheel motors 2 is transmitted to the front wheels (steerable wheel 1B) without passing through the continuously variable transmissions 100.

Referring next to FIG. 2 and FIG. 3, the in-wheel motor 2 and the continuously variable transmission 100 will be described. FIG. 2 schematically shows the internal structures of the in-wheel motor 2 and the continuously variable transmission 100. FIG. 3 is an enlarged view of the continuously variable transmission 100 shown in FIG. 2. The in-wheel motor 2 shown in FIG. 2 is one of the in-wheel motors 2 provided in the main drive wheels 1A. The in-wheel motors 2 provided in the steerable wheels 1B may have a conventional configuration, and therefore, will not be illustrated.

### 2-1. Wheel

Initially, the configuration of the wheel 1 which is common to the main drive wheels 1A and the steerable wheels 1B will be described. The wheel 1 is coupled to a drive shaft 11 so as to rotate as a unit with the drive shaft 11. The drive shaft 11 is driven with power of the in-wheel motor 2. A wheel 13 on which a tire 12 is mounted is coupled to the drive shaft 11 so as to rotate as a unit with the drive shaft 11. Also, a hub wheel 14 is integrated with the drive shaft 11, and the hub wheel 14 is fixed to the wheel 13 via a hub nut 15. Further, the drive shaft 11 protrudes from a motor housing 21 of the in-wheel motor 2 to the wheel 13 side.

In the main drive wheel 1A, the in-wheel motor 2 and the continuously variable transmission 100 are arranged side by side in the axial direction, and the drive shaft 11 is connected to the in-wheel motor 2 via the continuously variable transmission 100, such that power can be transmitted therebetween. On the other hand, in the steerable wheel 1B, the drive shaft 11 is configured to rotate as a unit with a rotor 22 of the in-wheel motor 2.

In this description, the central axis of rotation of the drive shaft 11 will be denoted as “first axis R1”. In addition, as a central axis of rotation different from the first axis R1, the central axis of rotation of each planetary ball 150 that will be described later will be denoted as “second axis R2”. When “axial direction”, “circumferential direction”, “radial direction” are simply mentioned, these mean respective directions based on the drive shaft 11. Further, when a phase that “rotate as a unit” is mentioned, it means that the central axis of rotation of a first rotating member is the same as that of a second rotating member.

The in-wheel motor 2 that is common to the main drive wheels 1A and the steerable wheels 1B is configured such that the rotor 22 and a stator 23 are housed within the motor housing 21. As shown in FIG. 2, the in-wheel motor 2 is of an inner rotor type, and the outside diameter of the motor housing 21 is smaller than a rim portion 13a of the wheel 13. The motor housing 21 is placed radially inward of the rim portion 13a of the wheel 13, and is supported by the vehicle body via a suspension (not shown). An annular stator 23 is fixed to an inner wall of the motor housing 21. The rotor 22 is placed radially inward of the stator 23. The rotor 22 has a hollow structure in which a plurality of permanent magnets 22a are arranged at regular intervals in the circumferential direction, on an outer circumferential surface of a rotor core, and the rotor 22 is placed on the drive shaft 11 such that it is rotatable about the first axis R1. The stator 23 has a plurality of tooth portions each of which is formed by laminating a plurality of annular electromagnetic steel sheets, and protrudes inward in a radial direction. In the stator 23, the tooth portions and slot portions are alternately formed in the circumferential direction, and three-phase electromagnetic coils 24 are wound around each tooth portion. The electromagnetic coils 24 are connected to the corresponding inverter 3.

At the time of driving the in-wheel motor 2, when a torque command (a signal indicative of a motor torque command value) is transmitted from the ECU 5 to the inverter 3, the inverter 3 causes given currents (three-phase alternating currents) to flow through the electromagnetic coils 24, so that a rotating electric field is generated in the stator 23. Then, the ECU 5 causes currents to sequentially flow through the electromagnetic coils 24 of respective phases in given timing, and the rotating magnetic field generated in the stator 23 moves in the circumferential direction, so that attraction and repulsion of the permanent magnets 22a are repeated. In this manner, the rotor 22 can be rotated at a desired rotational speed, and the wheel 1 can be driven in a desired rotational direction, at a desired rotational speed.

In the in-wheel motor 2 of the main drive wheel 1A, the motor housing 21 and a transmission case 101 are arranged side by side in the axial direction. The continuously variable transmission 100 is housed within the transmission case 101. The motor housing 21 and the transmission case 31 are mounted on the vehicle body such that they are non-rotatably fixed in position. In the embodiment shown in FIG. 2, the transmission case 101 is fixed in a condition where its wheel-side wall is in contact with a vehicle-body-side wall of the motor housing 21.

The in-wheel motor 2 further includes a rotor shaft 22b in the form of a hollow shaft, which rotates as a unit with the rotor 22 having a cylindrical shape. The rotor shaft 22b extends from the rotor 22 to the vehicle body side, and protrudes to the outside (on the vehicle-body side) of the motor housing 21, such that its distal end portion is located within the transmission case 101. The motor housing 21 is formed with a through-hole through which the rotor shaft 22b extends, and a bearing that supports the rotor shaft 22b is provided on an inner circumferential surface of the through-hole. The rotor shaft 22b is rotatably supported by the motor housing 21 via the bearing. Then, the rotor shaft 22b is connected to an input member 110 of the continuously variable transmission 100, so as to rotate as a unit with the input member 110.

The drive shaft 11 is placed inside the rotor 22 and the rotor shaft 22b. The drive shaft 11 is supported by bearings mounted on inner circumferential surfaces of the rotor 22 and the rotor shaft 22b, such that the drive shaft 11 is rotatable relative to the rotor 22 and the rotor shaft 22b, and is also rotatably supported by a bearing mounted on a wall portion (on the wheel side) of the motor housing 21. In the embodiment shown in FIG. 2, the drive shaft 11 extends through the interior of the motor housing 21, and its distal end portion on the vehicle body side is located within the transmission case 101. Then, the drive shaft 11 is connected to an output member 120 of the continuously variable transmission 100 so as to rotate as a unit with the output member 120.

In the in-wheel motor 2 of the steerable wheel 1B, the rotor 22 is coupled to the drive shaft 11 so as to rotate as a unit with the shaft 11. In the steerable wheel 1B, the drive shaft 11 functions as a rotor shaft of the in-wheel motor 2. In this case, the drive shaft 11 protrudes from the motor housing 21 only to the wheel 13 side.

The continuously variable transmission 100 includes an input member 110, an output member 120, a sun roller 130, and a carrier 140, as four rotating elements that are rotatable about the first axis R1 as a common center of rotation. The continuously variable transmission 100 further includes a plurality of planetary balls 150, as rotating elements that are rotatable about second axes R2 as centers of rotation.

The planetary balls 150 are members that transmit torque between the input member 110 and the output member 120. In the continuously variable transmission 100, the input member 110 and the planetary balls 150 are in frictional contact with each other, and the output member 120 and the planetary balls 150 are in frictional contact with each other, such that torque can be transmitted between the input member 110 and the output member 120 via the planetary balls 150. Also, the above-mentioned five rotating elements (input member 110, output member 120, sun roller 130, carrier 140, and planetary balls 150) can rotate relative to each other. For example, during transmission of torque, the planetary balls 150 roll on an outer circumferential surface 131 of the sun roller 130.

The continuously variable transmission 100 can steplessly or seamlessly change the speed ratio, by changing the tilting angle of the planetary balls 150. The tilting angle of the planetary ball 150 refers to an angle by which the rotation center axis (the second axis R2) of the planetary ball 150 is tilted relative to the first axis R1. As shown in FIG. 3, the planetary balls 150 are tiltably held by the carrier 140, such that the balls 150 are sandwiched between the input member 110 and the output member 120. In the continuously variable transmission 100, the carrier 140 causes the rotation center axes (the second axes R2) of the planetary balls 150 to be tilted relative to the first axis R1, so that the planetary balls 150 can be tilted. The carrier 140 is a rotating element for rotating the planetary balls 150, namely, a rotating element for changing the speed ratio of the continuously variable transmission 100.

More specifically, the carrier 140 is configured to be rotated by the shift actuator. With the carrier 140 thus rotated, the tilting angle of the planetary balls 150 can be changed. As shown in FIG. 3, by rotating the carrier 140, it is possible to change the continuously variable transmission 100 from a condition where the rotation center axis (the second axis R2) of each planetary ball 150 is in parallel with the first axis R1 (tilting angle=0°), to a condition where the rotation center axis (the second axis R2) of the planetary ball 150 is tilted or inclined relative to the first axis R1 (tilting angle≠0°. When the tilting angle of the planetary balls 150 is equal to 0°, the speed ratio of the continuously variable transmission 100 is equal to 1 (γ=1). On the other hand, when the tilting angle of the planetary balls 150 is not equal to 0° (tilted condition), the speed ratio of the continuously variable transmission 100 is smaller than 1 or larger than 1 (γ<1 or 1<γ). In FIG. 2 and FIG. 3, a reference condition in which the rotation center axes (the second axes R2) of the planetary balls 150 are in parallel with the first axis R1 is illustrated.

Further, in the continuously variable transmission 100, appropriate frictional force (traction force) is generated at contact faces between the input member 110 and the planetary balls 150, and contact faces between the output member 120 and the planetary balls 150. As shown in FIG. 3, the input member 110 and the output member 120 are arranged to be opposed to each other in the axial direction, and can rotate relative to each other in a condition where the planetary balls 150 are sandwiched between the input member 110 and the output member 120. Therefore, the continuously variable transmission 100 is configured to generate appropriate frictional force during torque transmission, by pressing at least one of the input member 110 and the output member 120 against the planetary balls 150 by means of a torque cam(s).

The input member 110 is connected with the rotor 22 (rotor shaft 22b) so as to rotate as a unit with the rotor 22. As shown in FIG. 3, a hollow input shaft 112 is connected to the input member 110 via an input-side torque cam 111, so as to rotate as a unit with the input member 110. The input-side torque cam 111 is a mechanism (pressing mechanism) that generates force to press the input member 110 against the planetary balls 150 when torque is applied to the cam 111. The inner periphery of one end portion (on the wheel side) of the input shaft 112 is spline-fitted on the outer periphery of the rotor shaft 22b, and the other end (vehicle-body side) of the input shaft 112 is connected to the input member 110 via the input-side torque cam 111. Namely, the input shaft 112 rotates as a unit with the rotor 22.

For example, when torque is transmitted from the rotor 22 to the input shaft 112, the torque is transmitted from the input shaft 112 to the drive shaft 11, via the input-side torque cam 111, input member 110, planetary balls 150, output member 120, output-side torque cam 121, and the output shaft 122. At this time, as the input member 110 rotates, frictional force is generated at contact faces between the input member 110 and the planetary balls 150, so that the planetary balls 150 rotate (about their own axes). Then, frictional force is also generated at contact faces between the planetary balls 150 and the output member 120, and contact faces between the planetary balls 150 and the sun roller 130, so that the output member 120 and the sun roller 130 also rotate.

The hollow input shaft 112 has a large-diameter shaft portion 112a that has the largest outside diameter, among rotating members that constitute the continuously variable transmission 100. As shown in FIG. 3, the input member 110, input-side torque cam 111, and the output member 120 are placed radially inside of the large-diameter shaft portion 112a. The input-side torque cam 111 and the large-diameter shaft portion 112a are connected with each other via a connecting member 113, so as to rotate as a unit with each other. The connecting member 113 is an annular member, and extends radially inward from an end portion (on the vehicle body side) of the large-diameter shaft portion 112a.

The input-side torque cam 111 can regard the connecting member 113 as a first cam member, and regard the input member 110 as a second cam member. In this case, an input-side cam face is formed on the connecting member 113, while an output-side cam face is formed on the input member 110, and the cam faces are arranged to be opposed to each other in the axial direction.

The output member 120 is connected to the wheel 1 (drive shaft 11) so as to rotate as a unit with the wheel 1. As shown in FIG. 3, a hollow output shaft 122 is connected to the output member 120 via the output-side torque cam 121, so as to rotate as a unit with the output member 120. The output-side torque cam 121 is a mechanism (pressing mechanism) that generates force to press the output member 120 against the planetary balls 150 when torque is applied to the cam 121. The inner periphery of one end portion (on the wheel side) of the output shaft 122 is spline-fitted on the outer periphery of the drive shaft 11, and the other end (vehicle-body side) of the output shaft 122 is connected to the output member 120 via the output-side torque cam 121. Namely, the output shaft 122 rotates as a unit with the drive shaft 11. Further, the output shaft 122 can rotate relative to the input shaft 112 and the rotor shaft 22b.

For example, when torque is transmitted from the wheel 1 to the output shaft 122, during regenerative braking, the torque is transmitted from the output shaft 122 to the rotor 22, via the output-side torque cam 121, output member 120, planetary balls 150, input member 110, input-side torque cam 111, and the input shaft 112. At this time, as the output member 120 rotates, frictional force is generated at contact faces between the output member 120 and the planetary balls 150, and the planetary balls 150 rotate (about their own axes). Then, frictional force is also generated at contact faces between the planetary balls 150 and the input member 110, and contact faces between the planetary balls 150 and the sun roller 130, so that the input member 110 and the sun roller 130 also rotate.

The input member 110 has input contact faces 110a that contact with the planetary balls 150. Similarly, the output member 120 has output contact faces 120a that contact with the planetary balls 150. The input contact faces 110a and the output contact faces 120a are arranged to be opposed to each other in the axial direction, at positions (in radial directions) where the planetary balls 150 are sandwiched between the corresponding input contact faces 110a and output contact faces 120a.

As shown in FIG. 3, each of the contact faces 110a, 120a is in contact with an outer peripheral curved surface, as a part of a surface of each planetary ball 150, which is located radially outward of the first axis R1. For example, each contact face 110a, 120a is formed as a concave arcuate surface having the same radius of curvature as that of the outer peripheral curved surface of the planetary ball 150. In this case, the planetary ball 150 is in surface contact with the respective contact faces 110a, 120a.

Each of the contact faces 110a, 120a may be formed as a concave arcuate surface having a different radius of curvature from that of the outer peripheral curved surface of the planetary ball 150, or may be formed as a convex arcuate surface, or a flat surface. In this case, the planetary ball 150 is in point contact with the respective contact faces 110a, 120a.

The radial positions of the respective contact faces 110a, 120a are determined such that the distance from the first axis R1 to a contact portion of each contact face 110a, 120a with the planetary ball 150 is equal, in the reference condition in which the tilting angle of the planetary balls 150 is equal to 0°. With this arrangement, a contact angle θ of the input member 110 with the planetary ball 150 is equal to a contact angle θ of the output member 120 with the planetary ball 150. The contact angle θ refers to an angle of a contact line relative to a reference line that passes the center of gravity of the planetary ball 150 and extends in a radial direction, on a plane including the first axis R1 and the second axis R2. The contact line refers to a line that extends from the center of gravity of the planetary ball 150 to a contact portion of the ball 150 with each contact face 110a, 120a on the same plane.

When force is applied in the axial direction from the input member 110 and the output member 120 to the planetary balls 150 by means of the respective torque cams 111, 121, force is also applied radially inward from the respective contact faces 110a, 120a to the planetary balls 150. The force applied radially inward is applied to the sun roller 130 via the planetary balls 150. As a result, frictional force is generated at contact faces between the planetary balls 150 and the sun roller 130.

Each of the planetary balls 150 is rotatably supported by a support shaft 151, so as to rotate about the second axis R2 as the center of rotation. As shown in FIG. 3, the planetary ball 150 can rotate on the second axis R2 that is the central axis of rotation of the support shaft 151, and is tiltably held by the carrier 140 via the support shaft 151.

Also, a plurality of planetary balls 150 are arranged at given intervals in the circumferential direction, on the same circle having a center on the first axis R1. As shown in FIG. 3, each of the planetary balls 150 is formed as a sphere whose cross-sectional shape including the center of gravity is a perfect circle. It is, however, to be understood that the planetary ball 150 may be any type of sphere provided that it is able to tilt, and may be a sphere, such as a rugby ball, having an elliptic cross-section.

The support shaft 151, which extends through the center of gravity of the corresponding planetary ball 150, has opposite end portions 151a, 151b that protrude from the planetary ball 150. One end portion 151a of the support shaft 151 protrudes from the planetary ball 150 toward the wheel in the axial direction, and is held by a fixed carrier 141 that will be described later. The other end portion 151b of the support shaft 151 protrudes from the planetary ball 150 toward the vehicle body in the axial direction, and is held by a rotary carrier 142 that will be described later.

The sun roller 130 is a cylindrical rotating member having an outer circumferential surface 131 that functions as a rolling surface of the planetary balls 150. The sun roller 130 rotates as each of the planetary balls 150 rolls on the outer circumferential surface 131. As shown in FIG. 3, the sun roller 130 is placed radially inward of the planetary balls 150, and is provided on a fixed shaft 160 via bearings. The sun roller 130 may be in the form of a single cylindrical member, or may consist of two or more cylindrical members.

The fixed shaft 160 is disposed on the first axis R1, and one end portion (on the wheel side) is located within the transmission case 101, while the other end portion (on the vehicle-body side) protrudes outside (on the vehicle-body side) of the transmission case 101. The carrier 140 is also provided on the fixed shaft 160.

The carrier 140 has a non-rotatable fixed carrier 141, a rotatable rotary carrier 142, and a non-rotatable fixed plate 143, as disc-like members having their centers on the first axis R1. In the carrier 140, the rotary carrier 142, plate 143, and the fixed carrier 141 are arranged in this order in the axial direction. The fixed carrier 141 and the rotary carrier 142 are disposed on the axially opposite sides of the planetary balls 150, with the plate 143 interposed between the carriers 141, 142. Then, the planetary balls 150 are held by the carrier 140 such that the balls 150 can perform tilting actions.

The fixed carrier 141 is a fixed member that holds one end portion 151a of the support shaft 151 of each planetary ball 150. As shown in FIG. 3, the fixed carrier 141 is placed on the wheel side (the right-hand side in FIG. 3) of the planetary balls 150 in the axial direction, and is placed radially inward of the output-side torque cam 121. Also, a radially inner portion of the fixed carrier 140 is fixed to a flange portion of the fixed shaft 160 via bolts, or the like.

The rotary carrier 142 is a rotating member that holds the other end portion 151b of the support shaft 151 of each planetary ball 150. As shown in FIG. 3, the rotary carrier 142 is placed on the vehicle-body side (the left-hand side in FIG. 3) of the planetary balls 150 in the axial direction, and is placed radially inward of the input-side torque cam 111. Also, the rotary carrier 142 is mounted on an outer periphery of the fixed shaft 160 such that it can rotate relative to the shaft 160.

The rotary carrier 142 is rotated by the shift actuator, during shifting operation. The shift actuator has a drive unit, such as an electric motor, and has a transmitting member (such as a worm gear) that connects the electric motor with the rotary carrier 142 such that torque can be transmitted therebetween. Then, the torque generated from the electric motor is transmitted to the rotary carrier 142 via the transmitting member, so that the rotary carrier 142 rotates relative to the fixed carrier 141. The rotary carrier 142 can rotate in both directions within a given angular range.

The plate 143 is a fixed member that holds a shaft portion 151c of the support shaft 151 of each planetary ball 150, between the fixed carrier 141 and the rotary carrier 142. The support shaft 151 extends through the plate 143. As shown in FIG. 3, the plate 143 is placed between the planetary balls 150 and the rotary carrier 142 in the axial direction, and is fixed to the fixed carrier 141 via two or more connecting shafts (not shown). The fixed carrier 141 and the plate 143 are integrally connected by the connecting shafts, to provide a cage-like structure as a whole, which covers the planetary balls 150.

Thus, the plate 143 holds the shaft portions 151c of the support shafts 151, and the fixed carrier 141 and the rotary carrier 142 hold the opposite end portions 151a, 151b of the support shafts 151, so that force that causes the support shafts 151 to be inclined relative to the first axis R1 is generated as the rotary carrier 142 rotates. With the force thus applied to the support shafts 151, the positions of the opposite end portions 151a, 151b in radial directions are changed, so that the planetary balls 150 can be tilted.

For the tilting operation, each constituent element of the carrier 140 is provided with guide portions for moving (guiding) the support shafts 151 in radial directions during shifting. With the guide portions the provided, the support shafts 151 are held by the carrier 140 such that they can perform tilting actions.

The fixed carrier 141 is formed with a plurality of fixed guide portions 141a for guiding one end portions 151a of the support shafts 151 in radial directions. The fixed guide portions 141a, which are grooves that extend straight in radial directions, are formed in respective faces of the fixed carrier 141 which are opposed to the planetary balls 150. For example, the fixed guide portions 141a are formed radially about the first axis R1.

The rotary carrier 142 is formed with a plurality of rotary guide portions 142a for guiding the other end portions 151b of the support shafts 151 in radial directions. The rotary guide portions 142a, which are grooves that extend straight in directions inclined relative to the radial directions, are formed in respective faces of the rotary carrier 142 which are opposed to the planetary balls 150. When the rotary carrier 142 is viewed in the axial direction, each of the rotary guide portions 142a has a pair of groove walls that are inclined relative to the radial direction. Therefore, the radial positions of the opposite end portions 151a, 151b of each support shaft 151 are determined by the groove walls of the corresponding rotary guide portion 142a. The rotary guide portion 142a is not limited to a straight groove, but may be a groove that extends in the shape of a curve. For example, a plurality of rotary guide portions 142a may be formed in a helical fashion about the first axis R1.

The plate 143 is formed with a plurality of slit portions 143a for guiding the shaft portions 151c of the support shafts 151 in radial directions. The slit portions 143a are formed radially about the first axis R1, to extend straight in radial directions. When the carrier 140 is viewed in the axial direction, the slit portions 143a are formed at the same positions and in the same shape as the fixed guide portions 141a.

When the carrier 140 is viewed as a whole in the axial direction, the rotary guide portions 142a are formed so as to intersect with the fixed guide portions 141a. This intersecting relationship is always established within an angular range over which the rotary carrier 142 can rotate. Further, the slit portions 143a are formed at the same positions and in the same shape as the fixed guide portions 141a; therefore, as the rotary carrier 142 rotates during shifting operation, the intersecting position between each rotary guide portion 142a and the corresponding slit portion 143a changes or shifts in the radial direction. Thus, during shifting operation, the opposite end portions 151a, 151b of the support shaft 151 can be moved to given radial positions along the radial direction, without being skewed relative to the radial direction.

During shifting operation, force that tilts the planetary balls 150 is applied from the carrier 140 to the support shafts 151, so that the planetary balls 150 perform tilting actions. More specifically, as the rotary carrier 142 rotates, force is applied in a radial direction from each rotary guide portion 142a to the other end portion 151b of the corresponding support shaft 151. As the other end portion 151b is moved radially outward, or moved radially inward, the corresponding one end portion 151a of the support shaft 151 is moved radially inward, or moved radially outward, along the fixed guide portion 141a. Thus, the opposite end portions 151a, 151b of the support shaft 151 are moved to different positions in the radial direction, so that the tilting angle of the planetary ball 150 changes. The tilting angle changes about the center (the position of the center of gravity) of the planetary ball 150, in a plane including the first axis R1 and the second axis R2. Namely, the continuously variable transmission 100 is configured to be able to change the tilting angle of each planetary ball 150, without changing the position of the center of gravity of the planetary ball 150.

As described above, according to the first embodiment, the continuously variable transmission 100 can be provided, in the power transmission path between the wheel 1 and the in-wheel motor 2. Thus, the speed ratio of the continuously variable transmission 100 can be changed during traveling, and the vehicle Ve installed with the in-wheel motors 2 can exhibit sufficient driving characteristics. Also, since the speed ratio can also be changed during regenerative braking, the amount of electric power regenerated by the in-wheel motor 2 can also be increased.

Further, the continuously variable transmission 100 can steplessly or seamlessly change the speed ratio by tilting the planetary balls 150. Thus, the size and weight of the continuously variable transmission 100 are smaller than those of known automatic transmissions and belt-type continuously variable transmissions. Therefore, the continuously variable transmission 100 can be readily mounted or installed on the vehicle Ve including the in-wheel motor 2.

The continuously variable transmissions 100 are provided only in the main drive wheels 1A, but not in the steerable wheels 1B. This arrangement makes it possible to secure sufficient maneuverability by use of the steerable wheels 1B, while improving the driving performance by use of the main drive wheels 1A. This is because, if the continuously variable transmissions 100 are connected to the steerable wheels 1B, the maneuverability of the steerable wheels 1B may deteriorate due to the weight of the continuously variable transmissions 100. Further, since the continuously variable transmissions 100 need not be mounted in all of the wheels 1, the manufacturing cost can also be reduced.

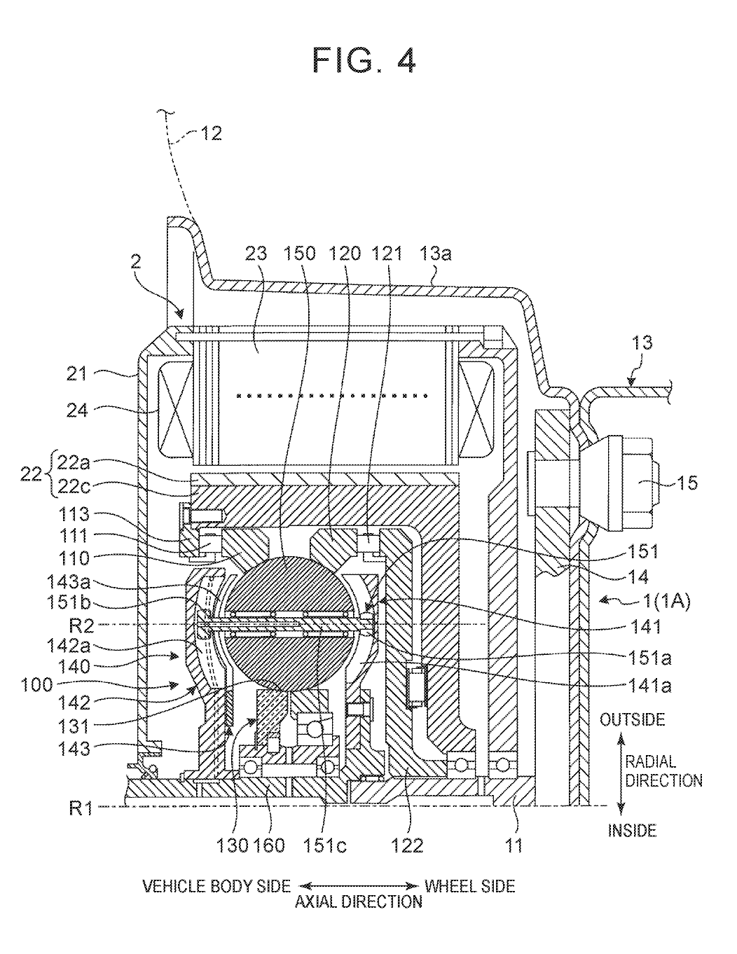

Referring next to FIG. 4, a vehicle Ve of a second embodiment will be described. FIG. 4 schematically shows the internal structures of an in-wheel motor 2 and a continuously variable transmission 100 according to the second embodiment. The second embodiment is different from the first embodiment in that the continuously variable transmission 100 is placed radially inside a stator 23. In the description of the second embodiment, the same or similar configuration as that of the above first embodiment will not be described, and the same reference numerals as those of the first embodiment will be assigned to the same or corresponding components.

As shown in FIG. 4, the continuously variable transmission 100 of the second embodiment is stored within a motor housing 21. Further, the in-wheel motor 2 includes a hollow rotor 22 that functions as the input shaft 112 of the first embodiment. The rotor 22 has a cylindrical rotor core 22c having permanent magnets 22a arranged on an outer circumferential surface thereof. Radially inside the cylindrical rotor core 22c, an input-side torque cam 111, input member 110, planetary balls 150, output member 120, output-side torque cam 121, and an output shaft 122 are placed. Namely, the rotating members that constitute the continuously variable transmission 100 are provided at positions that overlap the axial position at which the rotor 22 is placed. Also, one end portion (wheel-side end portion) of a fixed shaft 160 of the continuously variable transmission 100 is located inside the motor housing 21, and the other end portion (vehicle-body-side end portion) of the fixed shaft 160 protrudes outward of the motor housing 21.

As described above, according to the second embodiment, the continuously variable transmission 100 is placed radially inside the stator 23; therefore, the axial length of the continuously variable transmission 100, when it is installed on the vehicle, is less likely or unlikely to be increased. Thus, the axial length can be reduced, and the mountability of the continuously variable transmission 100 can be improved.

Also, the second embodiment does not have the transmission case 101 of the first embodiment; therefore, the vehicle of the second embodiment can be constructed with smaller size and lighter weight, than that of the first embodiment.

It is to be understood that the disclosure is not limited to each of the above embodiments, but the embodiments may be modified as needed, without departing from the object of this disclosure.

For example, the continuously variable transmission 100 may be in the form of a traction drive type continuously variable transmission (CVP). In this type of transmission, transmission oil (traction oil) is interposed between contact faces of the rotating elements of the continuously variable transmission 100, and power is transmitted via the transmission oil. In the continuously variable transmission 100, the transmission oil interposed between the rotating elements is sheared by rotating force of the rotating elements, so that resistive force (traction force) is generated between the rotating elements, using the transmission oil. The resistive force makes it possible to transmit power between the rotating elements.

Further, an oil passage is formed in the fixed shaft 160, and the oil passage is connected to a hydraulic circuit (not shown) provided outside the transmission case 101 and the motor housing 21. With this arrangement, oil is supplied to the interiors of the transmission case 101 and the motor housing 21, via the oil passage of the fixed shaft 160. An oil passage is also provided inside the drive shaft 11, and the oil passage is connected to the oil passage of the fixed shaft 160. Namely, oil serving as transmission oil is supplied to the interior of the transmission case 101, and oil serving as cooling oil is supplied to the interior of the motor housing 21. Thus, the oil passage structure is simplified, and the structures of the continuously variable transmission 100 and the in-wheel motor 2 can be downsized. Also, the transmission case 101 is sealed so that the transmission oil supplied to the inside of the case is prevented from leaking to the outside of the case.

The continuously variable transmission 100 is not limitedly configured to perform tilting operation by rotating the carrier 140. For example, the carrier may have an arm for tiling, which holds opposite end portions 151a, 151b of each support shaft 151, and may be arranged to tilt the planetary ball 150 by moving the tilting arm in a radial direction. In this case, the shift actuator is configured to move the arm for tilting in the radial direction. More specifically, the arm for tilting is coupled to a shift shaft that can move in the axial direction, and its coupling portion is formed by a tapered face. The shift shaft can slide on the fixed shaft 160 in the axial direction. As the shift shaft moves in the axial direction, force that causes the arm for tilting to move in the radial direction is generated via the tapered face of the coupling portion. In this case, the shift actuator is configured to generate force that moves the shift shaft in the axial direction.

The vehicle Ve is not limited to a four-wheel-drive vehicle. For example, the vehicle Ve may have four or more wheels 1. In this case, too, the continuously variable transmissions 100 are provided only for the rear wheels serving as the main drive wheels 1A. Where the vehicle Ve is a six-wheel-drive vehicle, as one example, the front two wheels are steerable wheels 1B, and the rear four wheels are main drive wheels 1A. In this case, the continuously variable transmissions 100 are provided in the four wheels 1 as the rear wheels.

Where the vehicle Ve includes six or more wheels 1, it is not limited to an electric vehicle, but may be a hybrid vehicle on which an engine is installed as a power source for traveling. In this case, four or more wheels 1 other than the front two wheels may function as main drive wheels 1A. In the case of a six-wheel-drive vehicle Ve, for example, four main drive wheels 1A may be configured such that power of the in-wheel motors 2 is transmitted to two of the main drive wheels 1A, and power of the engine is transmitted to the remaining two of the main drive wheels 1A.

In the vehicle according to the disclosure, the wheels may include main drive wheels and steerable wheels, and the continuously variable transmission may be connected only to each of the main drive wheels.

With the vehicle as described above, the continuously variable transmission is not connected to any of the steerable wheels; therefore, the maneuverability of the steerable wheels is less likely or unlikely to be reduced due to the weight of the continuously variable transmission. Namely, the steerable wheels are light in weight, and the maneuverability can be secured. Further, since the continuously variable transmission is not provided for any of the steerable wheels, the manufacturing cost can be reduced. Also, since the continuously variable transmission is connected to each of the main drive wheels, the vehicle can exhibit sufficient power characteristics.

In the vehicle as described above, the wheels may include rear wheels that provide the main drive wheels, and front wheels that provide the steerable wheels, and the continuously variable transmission may be provided only in each of the rear wheels.

With the vehicle as described above, the front wheels serve as steerable wheels, and the rear wheels serve as main drive wheels. With this arrangement, the vehicle attitude is likely to be stabilized during turning, for example.

In the vehicle as described above, the in-wheel motor may be of an inner rotor type, and the continuously variable transmission may be placed radially inside the stator.

With the vehicle as described above, the structure of the continuously variable transmission and the in-wheel motor can be constructed with the reduced axial length. As a result, the size can be further reduced, and the mountability is improved.

What is claimed is:

1. A vehicle including a plurality of wheels, the vehicle comprising:
an in-wheel motor placed inside each of the wheels, the in-wheel motor including a rotor and a stator; and
a continuously variable transmission provided for at least one of the wheels and placed in a power transmission path between the in-wheel motor and a corresponding one of the wheels, the continuously variable transmission being configured to steplessly change a speed ratio,
the continuously variable transmission including an annular input member, an annular output member, a plurality of planetary balls, a support shaft, and a carrier,
the annular input member rotating as a unit with the rotor,
the annular output member rotating as a unit with a drive shaft of the corresponding one of the wheels,
the plurality of the planetary balls sandwiched between the input member and the output member that are arranged to be opposed to each other in an axial direction of the drive shaft, the planetary balls being configured to transmit torque between the input member and the output member,
the support shaft including opposite end portions that protrude from each of the planetary balls, and supports the planetary ball such that the planetary ball is rotatable about an axis of rotation that is different from that of the drive shaft,
the carrier configured to tilt the planetary balls, by changing positions of the opposite end portions of the support shaft along a radial direction of the drive shaft, without changing a position of a center of gravity of the each planetary ball,
the continuously variable transmission being configured to change the speed ratio by changing a tilting angle of the planetary balls.

2. The vehicle according to claim 1, wherein
the wheels include main drive wheels and steerable wheels, and the continuously variable transmission is connected only to each of the main drive wheels.

3. The vehicle according to claim 2, wherein
the wheels include rear wheels that provide the main drive wheels, and front wheels that provide the steerable wheels, and the continuously variable transmission is provided only in each of the rear wheels.

4. The vehicle according to claim 1, wherein
the in-wheel motor is of an inner rotor type, and the continuously variable transmission is placed radially inside the stator.
